(19) United States
(12) Patent Application Publication
(10) Pub. No.: US 2007/0071475 A1
(43) Pub. Date: Mar. 29, 2007

(54) Method of controlling throughput of media in a printer

(75) Inventors: Bryan M. Blair, Lexington, KY (US); Jichang Cao, Lexington, KY (US); James D. Gilmore, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/234,349

(22) Filed: Sep. 23, 2005

(51) Int. Cl. G03G 15/20

(52) U.S. Cl. 399/68

(57) ABSTRACT

A method of controlling throughput of media passing through a heat fixing device includes the steps of initially conveying media to the heat fixing device at a nominal interpage gap, and counting a number of substrates conveyed through the heat fixing device. After a predetermined number of substrates have been conveyed through the heat fixing device, a temperature related measurement is obtained at the heat fixing device; and the interpage gap is increased when the temperature related measurement is a predetermined value. The interpage gap may be increased a large amount for a temperature related measurement corresponding to a narrow media, and the interpage gap may be increased a small amount for a temperature related measurement corresponding to nearly narrow media. The temperature related measure is obtained from a temperature sensor located in spaced relation to a temperature sensor providing a signal for controlling power to a heater for the heat fixing device.

### BACKGROUND OF THE INVENTION

1. Field of the Invention

The present invention relates to a method of controlling the throughput of media in a printer and, more particularly, to a method including a control algorithm for controlling the interpage gap of media conveyed through a heat fixing device in a printer.

2. Related Prior Art

In an electrophotographic image forming apparatus, such as a printer or copier, a latent image is formed on a light sensitive drum and developed with toner. The toner image is then transferred onto media, such as sheets of paper, and is subsequently passed through a fuser where heat and pressure are applied to melt and adhere the unfused toner to the surface of the media. There are a variety of devices to apply heat and pressure to the media such as radiant fusing, convection fusing, and contact fusing. Contact fusing typically comprises cooperating nip forming members such as cooperating rollers capable of delivering heat and pressure to the media, a single fuser roller in contact with a rotating belt or a belt backup roller fusing system. The fuser roller may be provided with an internal heater, such as a halogen lamp, and the temperature of the fuser roller may be monitored by a temperature control sensor providing a temperature signal for controlling the temperature of the fusing operation to a predetermined target temperature. Generally, the temperature control sensor may be located in a media path traversed by all media sizes, i.e., including full width and narrow width media. For example, the temperature control sensor may be located adjacent a media reference edge or similar location that may be traversed by all media sizes processed by the fuser.

As media is processed through the fuser, heat is transferred from the fuser to the media in a media passing region traversed by the media, and the fuser is energized to maintain or control the fuser temperature to the predetermined temperature in the media passing region, as sensed by the temperature control sensor. When processing media having a width less than full width media for the printer, a non-media passing region of the fuser, i.e., a region outside of the area traversed by media having a size less than full width media, may exhibit increased temperatures. In order to avoid the non-media passing region overheating to temperatures that may cause damage to cooperating nip forming members, narrow media may be detected at the media tray or by a narrow media sensor in the media path to cause a control algorithm to be implemented for avoiding an overheat condition of the fuser.

Typically, algorithms for controlling media flow through a fuser generally classify media into two categories, namely full width and narrow width media. Further, the narrow media algorithm may generally be triggered not only for narrow width media, but also for other media having a width intermediate narrow and full width media.

Accordingly, there continues to be a need for a method of processing media in a printer, where the media throughput for narrow width media and media of widths intermediate full width and narrow width media may be maximized.

### SUMMARY OF THE INVENTION

The invention relates to a method of processing media in a printer that may vary the media throughput based on a variable related to media width to optimize the throughput of media as it is processed through a heat fixing device for the printer.

In accordance with one aspect of the invention, a method of controlling throughput of media passing through a heat fixing device is provided comprising the steps of: conveying media to the heat fixing device at a nominal interpage gap; counting a number of substrates conveyed through the heat fixing device; obtaining a temperature related measurement at the heat fixing device; and after a predetermined number of substrates have been conveyed through the heat fixing device, increasing the interpage gap when the temperature related measurement is a predetermined value.

In accordance with another aspect of the invention, a method of controlling throughput of media passing through a heat fixing device is provided comprising the steps of: conveying media to the heat fixing device; obtaining a temperature measurement from a first temperature sensor located in a portion of a media passing region where media of all widths may pass through the heat fixing device, said temperature sensor providing a temperature signal for effecting control of a heater for the heat fixing device; obtaining a temperature related measurement at the heat fixing device from a second temperature sensor for measuring a temperature of said heat fixing device in a portion of a media passing region where media having widths less than full width media may not pass through the heat fixing device; and adjusting an interpage gap between the media with reference to the temperature related measurement.

A fuser assembly within an image forming apparatus having a paper path along which substrates travel through the image forming apparatus is provided, the fuser assembly comprising a heating member, and a backup member cooperating with the heating member to form a nip therebetween for fusing images onto substrates passing through the nip. Structure is provided for conveying substrates along the paper path to the nip. Processing structure is provided for determining a temperature measurement from a first temperature sensor located at a portion of a media passing region where media of all widths may pass through the nip, and for determining a temperature related measurement from a second temperature sensor located at a portion of a media passing region where media having widths less than full width media may not pass through the nip; and the processing structure adjusts an interpage gap between the media with reference to the temperature related measurement.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is a schematic illustration of an electrophotographic printer in which the process of the present invention may be implemented;

FIG. 2 is a schematic plan view illustrating media conveyed through the fuser of the electrophotographic printer of FIG. 1;

FIG. 3 is a flowchart depicting a first embodiment illustrating the invention;

FIG. 4 is a flowchart depicting a second embodiment illustrating the invention; and

FIG. 5 is a flowchart depicting a third embodiment illustrating the invention.

### DETAILED DESCRIPTION OF THE INVENTION

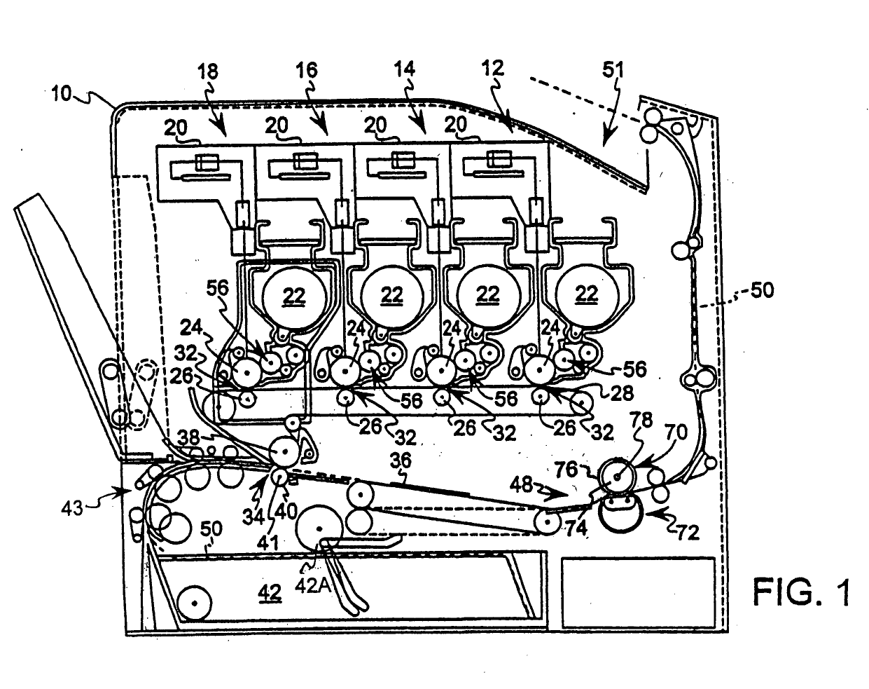

Referring to FIG. 1, a color electrophotographic (EP) printer 10 is illustrated including four image forming stations 12, 14, 16, 18 for creating yellow (Y), cyan (C), magenta (M) and black (K) toner images. Each image forming station 12, 14, 16 and 18 includes a laser printhead 20, a toner supply 22 and a developing assembly 56. Each image forming station 12, 14, 16 and 18 also includes a rotatable photoconductive (PC) drum 24. A uniform charge is provided on each PC drum 24, which is selectively dissipated by a scanning laser beam generated by a corresponding printhead 20, such that a latent image is formed on the PC drum 24. The latent image is then developed during an image development process via a corresponding toner supply 22 and developing assembly 56, in which electrically charged toner particles adhere to the discharged areas on the PC drum 24 to form a toned image thereon. An electrically biased transfer roller 26 opposes each PC drum 24. An intermediate transfer member (ITM) belt 28 travels in an endless loop and passes through a nip defined between each PC drum 24 and a corresponding transfer roller 26. The toner image developed on each PC drum 24 is transferred during a first transfer operation to the ITM belt 28 by an electrically biased roller transfer operation. The four PC drums 24 and corresponding transfer rollers 26 constitute first image transfer stations 32.

At a second image transfer station 34, a composite toner image, i.e., the yellow (Y), cyan (C), magenta (M) and black (K) toner images combined, is transferred from the ITM belt 28 to a substrate 36. The second image transfer station 34 includes a backup roller 38, on the inside of the ITM belt 28, and a transfer roller 40, positioned opposite the backup roller 38. Substrates 36, such as paper, cardstock, labels, envelopes or transparencies, are fed from a substrate supply 42 to the second image transfer station 34 so as to be in registration with the composite toner image on the ITM belt 28. Structure for conveying substrates from the supply 42 to the second image transfer station 34 may comprise a pick mechanism 42A that draws a top sheet from the supply 42 and a speed compensation assembly 43, see U.S. patent application Ser. No. ______, entitled Electrophotographic Device Capable of Performing an Imaging Operation and a Fusing. Operation at Different Speeds, filed concurrently herewith, assigned attorney docket no. 2004-0406.02, as well as U.S. Pat. No. 6,370,354 B1, the disclosures of which are incorporated herein by reference. The composite image is then transferred from the ITM belt 28 to the substrate 36. Thereafter, the toned substrate 36 passes through a fuser assembly 48, where the toner image is fused to the substrate 36. The substrate 36 including the fused toner image continues along a paper path 50 until it exits the printer 10 into an exit tray 51.

The paper path 50 taken by the substrates 36 in the printer 10 is illustrated schematically by a dot-dashed line in FIG. 1. It will be appreciated that other printer configurations having different paper paths may be used. Further, one or more additional media supplies or trays, including manually fed media trays, may be provided.

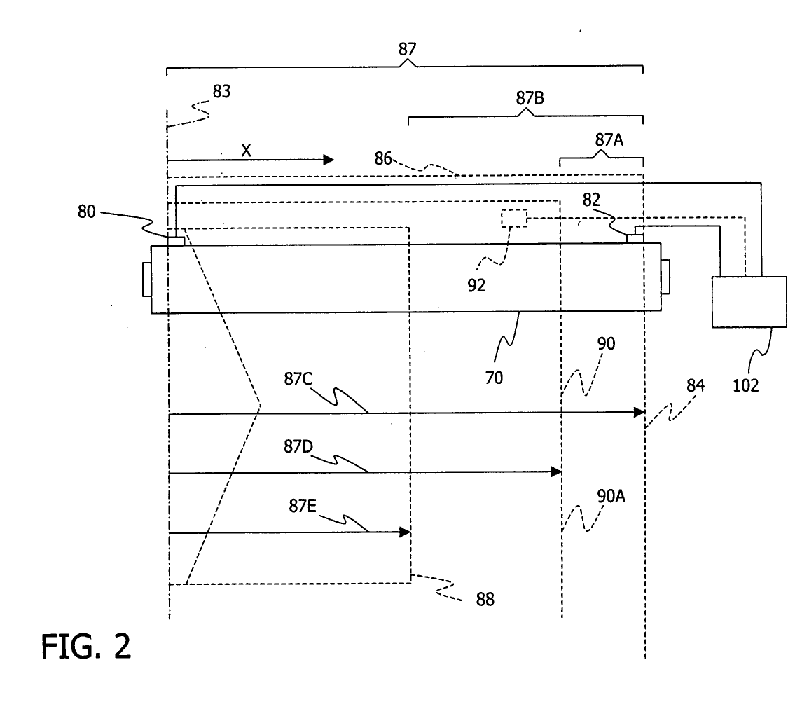

The fuser assembly 48 in the illustrated embodiment includes a fuser hot roller 70 or fusing roller defining a heating member, and a backup member 72 cooperating with the hot roller 70 to define a nip for conveying substrates 36 therebetween. The hot roller 70 may comprise a hollow metal core member 74 covered with a thermally conductive elastomeric material layer 76. The hot roller 70 may also include a PFA (polyperfluoroalkoxy-tetrafluoroethylene) sleeve (not shown) around its elastomeric material layer 76. A heater element 78, such as a halogen tungsten-filament heater, may be located inside the core 74 of the hot roller 70 for providing heat energy to the hot roller 70 under control of a print engine controller or processor 102. The heater element 78 may comprise a filament that provides an end boost along a predetermined portion adjacent at each end of the heater element 78 to provide a greater heat output adjacent the ends than at a central portion of the heater element 78. It should be understood that the illustrated embodiment is not limited to a particular mechanism or structure for heating the hot roller 70 and that any known means of heating a roller may be implemented within the scope of this invention. In addition, first and second temperature sensors 80, 82, see FIG. 2, may be provided adjacent opposing ends of the hot roller 70 for sensing a temperature of the hot roller 70 and for sending corresponding signals to the processor 102.

The backup member 72 may comprise any structure for cooperating with the hot roller 70 to create a nip whereby a substrate passing through the fuser 48 is pressed into engagement with the hot roller 70. The illustrated backup member 72 comprises a belt backup member. However, it should be understood that the backup member 72 may comprise other nip forming structures including, without limitation, a cooperating backup roller.

The printer 10 is capable of printing different widths of media, including normal or full width media, narrow width media and nearly narrow width media. Normal or full width media for a particular printer may comprise, for example, letter size media or A4 size media. Narrow width media may be generally classified for the purposes of the present description as media having a width less than approximately 6.5 inches, and may comprise A5 size paper and envelopes. Nearly narrow media may be classified for the purposes of the present description as media having a width approximately within the range of 6.5-8 inches, and may comprise B5 size paper and executive size paper. It should be understood that the categories of media described herein are provided for the purposes of illustrating the operation of the present invention and are not intended to be limiting to the broad concepts that comprise the invention.

Referring to FIG. 2, the first temperature sensor 80 is located to obtain a temperature measurement from the hot roller 70. The first temperature sensor 80 is positioned adjacent a reference edge 83 which in the illustrated embodiment comprises structure within the printer 10 defining a left-most edge along which all media conveyed through the fuser 48 will be aligned. A region 87 in the fuser 48 through which media travels is defined herein as a media passing region. The media passing region 87 comprises a first portion 87A where nearly narrow width media, i.e., media having widths less than full width media, may not pass through the fuser 48. The media passing region 87 further comprises a second portion 87B where narrow width media, i.e., media having widths less than full and nearly narrow width media, may not pass through the fuser 48. As is apparent from FIG. 2, a section of the second portion 87B overlaps the first portion 87A. Hence, narrow media also may not pass through the first portion 87A. The media passing region 87 has a full width media dimension 87C extending in an X-direction, see FIG. 2, from the reference edge 83 to a location where an outer edge 84 of a full width media is positioned, which outer edge is opposite to an edge of the full width media that moves along the reference edge 83. The media passing region 87 further comprises a nearly narrow width media dimension 87D extending in an X-direction from the reference edge 83 to a location where an outer edge 90A of a nearly narrow width media is positioned, which outer edge is opposite to an edge of the nearly narrow width media that moves along the reference edge 83. The media passing region 87 still further comprises a narrow width media dimension 87E extending in an X-direction from the reference edge 83 to a location where an outer edge 88 of a narrow width media is positioned, which outer edge is opposite to an edge of the narrow width media that moves along the reference edge 83.

The first temperature sensor 80 may be connected to the print engine controller or processor 102 for providing a temperature feedback for controlling power to the heater element 78. The second temperature sensor 82 is also connected to the processor 102 and is located to provide a temperature of the hot roller 70 at a longitudinally distal location from the first temperature sensor 80, see FIG. 2. Specifically, the second temperature sensor 82 is preferably positioned outside of the nearly narrow width media dimension 87D and preferably is adjacent the location of the longitudinal edge 84 of the full width media 86. Thus, the second temperature sensor 82 is positioned in a location that is outside of the media path of substantially all substrates except for full width substrates. The temperature measured at the second temperature sensor 82 may be substantially similar to the temperature at the first temperature sensor 80 when full width media is processed through the fuser 48 as a substantially constant amount of heat is transferred from the hot roller 70 to a full width media along the entire width of the full width media, see full width media dimension 87C in FIG. 2. Further, the temperature measured at the second temperature sensor 82 may be lower for full width media, for a given hot roller temperature and processing throughput, than a temperature measured for a narrower media that does not pass through the location of the second temperature sensor 82, i.e., that does not extend beyond the nearly narrow width media dimension 87D. Such media may comprise narrow media, illustrated as an envelope 88, or nearly narrow media, illustrated by substrate 90, e.g., B5 or executive size media. The lower temperature measured at the second temperature sensor 82 for a full width media, as compared to a temperature measured by the second sensor 82 for a nearly narrow or narrow media, results because paper is not present in at least the first portion 87A for receiving heat transferred from the hot roller 70.

The first and second temperature sensors 80, 82 may comprise any means for measuring the temperature of the hot roller 70 including, without limitation, thermistors located in contact with the hot roller 70. It should be understood that the present invention is not limited to a particular form of temperature sensing for determining a temperature of the hot roller 70 at the locations depicted by temperature sensors 80, 82, and may comprise, without limitation, contact or non-contact temperature sensors.

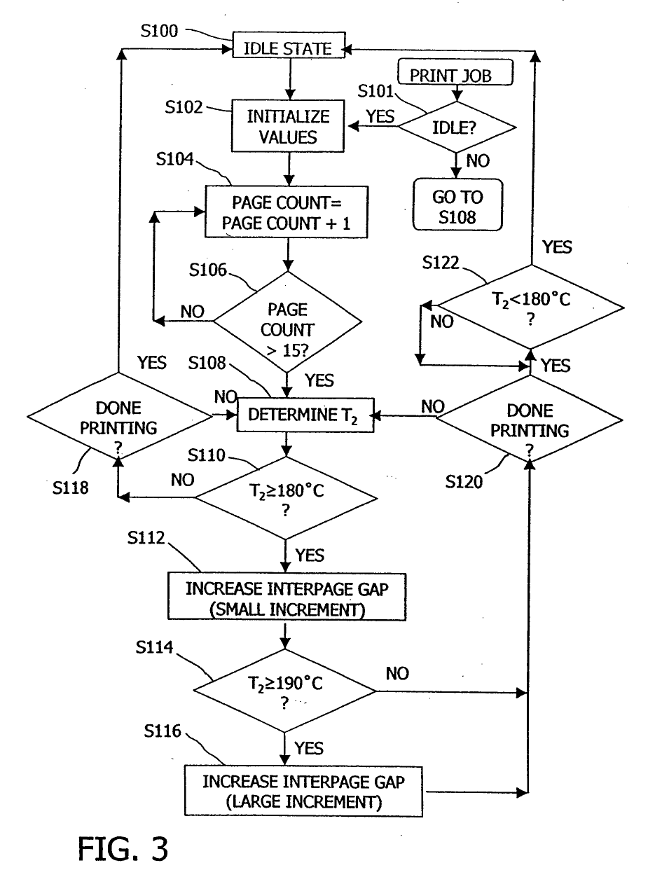

FIG. 3 is a flowchart depicting process steps implemented by the processor 102 in accordance with a first embodiment for controlling the throughput of media through the fuser 48 with reference to a temperature related measurement derived from the second temperature sensor 82. The processor 102 may implement the steps set forth in FIG. 3 at the beginning of a print job received by the printer when the printer is in a power saver mode, or when the printer is in a standby mode and the temperature of the hot roller 70 is less than a predetermined temperature, i.e., 180° C., as is described in further detail below. The printer is in a standby mode when the printer is initially turned on, or transfers to the standby mode a predetermined time period immediately after completion of a print job, wherein the temperature of the hot roller 70 is maintained at a predetermined temperature lower than a temperature for performing a print job; and the printer is in a power saver mode when the printer has not printed a print job for a predetermined period of time, wherein power to the heater element 78 of the hot roller 70 is turned off. A print job may comprise the printing of a single substrate or the continuous printing of two or more substrates of the same type, at the same nominal production rate and at the same hot roller temperature. Beginning at step S100, the printer is initially at an idle state, such as in the standby mode or the power saver mode. Upon initiation of a print job at the idle state, as determined at step S101, the process proceeds to step S102 where a page counter is initialized to zero and the interpage gap is initialized to zero corresponding to a nominal or standard interpage gap. For example, a nominal interpage gap may be 2 inches, and may be implemented by control of a paper pick operation. That is, substrates are picked and enter the paper path 50 at a rate such that a 2 inch gap is provided between sequentially picked substrates. All substrates, regardless of the media type and width, are processed through the printer at the nominal throughput, corresponding to the nominal interpage gap, until a predetermined page count is reached. At step S104, the page counter is incremented by one each time a substrate is processed and the page count is compared to a predetermined number in step S106. The signal for incrementing the page count may be obtained by monitoring a paper pick signal or by monitoring a media exit sensor signal such as may be provided at an exit section of the fuser 48. The predetermined number for the page count may fall generally within a range of 15-25 pages. In the present embodiment, the predetermined number of pages is set at 15 pages; however, it should be understood that the predetermined number may be selected for the particular characteristics of the printer and/or fuser in which the presently described process is implemented. If the page count has not exceeded the predetermined number, the process returns to step S104 to process a further substrate.

If the page count has exceeded the predetermined number in step S106, the process flow continues to step S108 where a temperature reading, T₂, is taken from the second temperature sensor 82. The process then proceeds to step S110 where T₂ is compared to a lower limit temperature, i.e., 180° C. in the present example. If T₂ is greater than or equal to the lower limit temperature, the process proceeds to step S112 and the throughput is reduced to an intermediate throughput value by increasing the interpage gap by a small increment. In the present embodiment, the intermediate throughput value is approximately ⅔ of the throughput provided by the nominal interpage gap and may generally correspond to adding approximately 2-5 inches to the nominal interpage gap. The throughput is reduced, i.e., the interpage gap is increased, by increasing the time period between when successive substrates are picked from the substrate supply 42.

The process continues to step S114 where T₂ is compared to an upper limit temperature, i.e., 190° C. in the present example. If T₂ is greater than or equal to the upper limit temperature, corresponding to a condition indicative of narrow media, the process proceeds to step S116 where the throughput is reduced to a low throughput value by further increasing the interpage gap by a large increment. In the present embodiment, the low throughput value is approximately ⅓ of the throughput provided by the nominal interpage gap and may generally correspond to adding approximately 6-11 inches to the nominal interpage gap.

If T₂ is less than 180° C. at step S110, corresponding to a condition indicative of full width media, the throughput remains at the initial throughput value, and the process proceeds to step S118 where a determination is made as to whether the printing of all print jobs received by the printer have been completed. That is, a determination is made as to whether the current print job has been completed and whether any further print jobs are waiting to be printed. If no further print jobs are to be performed, the process returns to step S100 and the printer goes to the standby mode, otherwise the process returns to step S108 to again obtain a temperature measurement from the second temperature sensor 82.

If T₂ is less than 190° C. at step S114, i.e., 180° C.≦T₂<190° C., corresponding to a condition indicative of nearly narrow media, the throughput remains at the intermediate throughput value. That is, the throughput remains at approximately ⅔ of the throughput provided by the nominal interpage gap, and the process proceeds to step S120 where a determination is made as to whether the current print job has been completed and whether any further print jobs are waiting to be printed. If no further print jobs are to be performed, the printer goes to the standby mode and the process goes to step S122 where a determination is made whether T₂ is less than 180° C. and, if so, the process returns to step S100, otherwise the process continues to perform a check at step S122 until T₂ drops below 180° C. During the time that the process remains at step S122, the interpage gap setting remains the same as for the last print job. If a print job is received subsequent to step S120 and prior to T₂ dropping below 180° C., the process exits the standby mode and begins the new print job at step S108. If additional printing is to be performed at step S120, the process returns to step S108 to again obtain a temperature measurement from the second temperature sensor 82.

If T₂ is greater than or equal to the upper limit temperature at step S114 and the process proceeds to step S116 to set the throughput to the low throughput value, i.e., approximately ⅓ of the throughput provided by the nominal interpage gap, the process further proceeds to step S120. Subsequently, the process continues as described above in relation to the steps S120, S122, S100 and S108.

In addition, if a further print job is waiting to be performed before the process described above returns to the idle state at step S100, the process for controlling the throughput of the subsequent print job will proceed directly from step S101 to step S108. That is, if a subsequent print job is initiated without the printer returning to a standby condition, the process will bypass the initialization step S102 and the steps S104 and S106 of processing the predetermined number of pages at the nominal throughput.

It should be noted that the algorithm described above may operate to control an increase in the interpage gap for all media types processed through the printer without direct reference to the particular media type being processed. However, if a predetermined number of pages of full width media, i.e., letter size media, such as 10 pages, is processed consecutively through the printer, the control for the interpage gap may return the interpage gap to the nominal value in order to optimize throughput of the media. In such a case, it is anticipated that the full width media will absorb heat across the substantially the full width of the hot roll 70, such that the temperature of the portion of the hot roll 70 adjacent the second temperature sensor T₂ will substantially approach the temperature measured by the first temperature sensor T₁.

It may be noted that the process, as illustrated by the first embodiment, permits control of media throughput without requiring input of a media width to optimize the throughput, while also providing protection of the fuser components against overheating when processing narrow and nearly narrow width media.

It should also be understood that the process, as described with reference to the first embodiment, is not limited to the particular temperatures and throughput speeds or incremental changes to interpage gaps described above. For example, although the above-described process has been described with reference to throughput values corresponding to a nominal interpage gap, approximately ⅔ of the nominal interpage gap and approximately ⅓ of the nominal interpage gap, other throughput values than those described may be provided. Further, a greater number of smaller incremental increases in the interpage gap may be made, where each incremental increase may be made with respect to a corresponding predetermined increase in T₂.

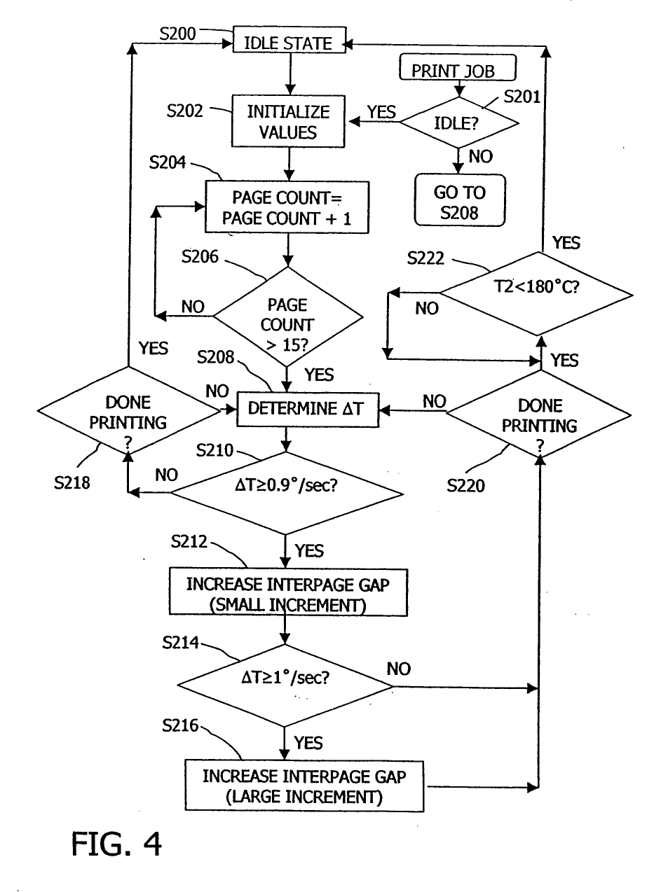

Referring to FIG. 4, a flowchart depicts process steps implemented by the processor 102 in accordance with a second embodiment for controlling the throughput of media through the fuser 48, where control of media throughput is effected in a manner similar to that described for the first embodiment; however, the throughput is adjusted based on a temperature related measurement comprising a gradient or rate of temperature change rather than on the basis of the actual measured temperature. Steps of the second embodiment corresponding to the first embodiment are labeled with the same reference numeral increased by 100.

Beginning at step S200, the printer is initially at an idle state, i.e., in the standby mode or the power saver mode. Upon initiation of a print job at the idle state, as determined at step S201, the process proceeds to step S202 where a page counter is initialized to zero and the interpage gap is initialized to zero corresponding to a standard or nominal interpage gap. All substrates, regardless of the media type, are processed through the printer at a nominal throughput, corresponding to a nominal interpage gap, until a predetermined page count is reached. At step S204, the page counter is incremented by one each time a substrate is processed and the page count is compared to a predetermined number in step S206. If the page count has not exceeded the predetermined number, the process returns to step S204 to process a further substrate.

After a predetermined number of substrates have initially been processed at the nominal throughput, a temperature increase gradient or rate of temperature increase at the second temperature sensor 82 may be determined, see step S208. Subsequently, the throughput is maintained at the nominal throughput, i.e., the nominal interpage gap, if the temperature gradient, ΔT, is less than a lower limit temperature increase gradient, i.e., ΔT<0.9° C./sec, see step S210; the interpage gap is increased by a small increment to decrease the throughput to approximately ⅔ of the nominal throughput if the temperature gradient, ΔT, is greater than or equal to the lower limit temperature gradient and is less than an upper temperature increase gradient, i.e., 0.9° C./sec≦ΔT<1° C./sec, see steps S212 and S214; and the interpage gap is increased a large amount to decrease the throughput to approximately ⅓ of the nominal throughput if the temperature gradient, ΔT, is greater than or equal to an upper limit temperature increase gradient, i.e., 1° C./sec≦ΔT, see step S216.

The remaining steps for the process of the second embodiment are performed in a manner substantially similar to the corresponding steps described for the first embodiment.

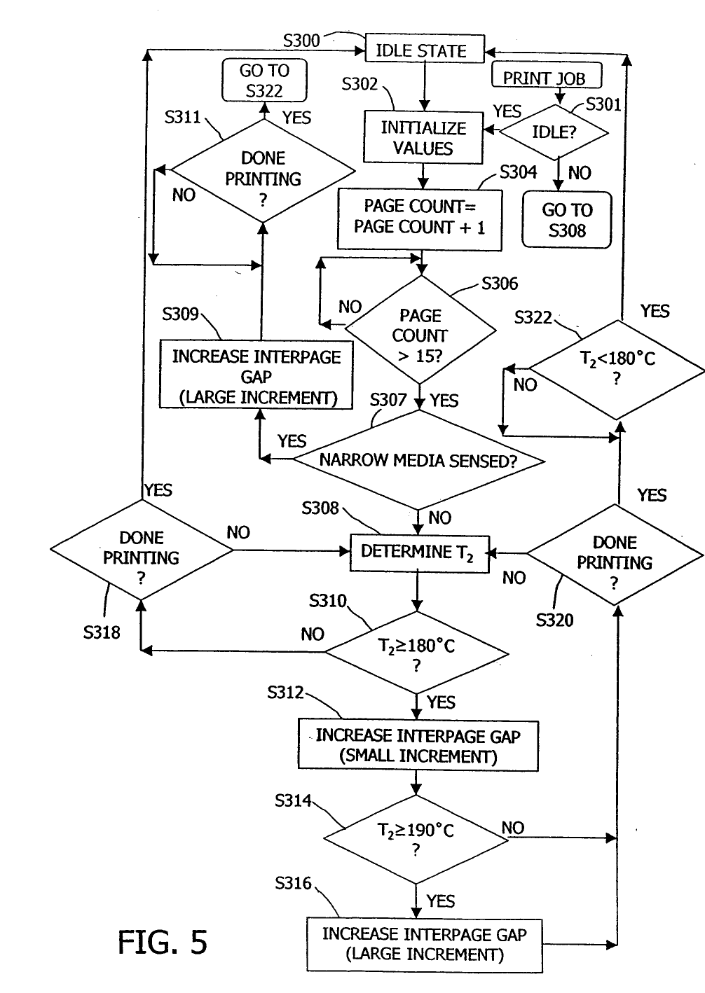

Referring to FIG. 5, a flowchart depicts process steps implemented by the processor 102 in accordance with a third embodiment for controlling the throughput of media through the fuser 48 with reference to a temperature related measurement comprising the temperature of the second temperature sensor 82, and with reference to a narrow media sensor 92, see FIG. 2. The narrow media sensor 92 may be positioned to identify media less than 6.5 inches wide as narrow media. The process of the third embodiment is similar to that of the first embodiment, except for the particular differences noted below, and the steps of the third embodiment corresponding to those of the first embodiment are labeled with the same reference numeral increased by 200.

Beginning at step S300, the printer is initially at an idle state, i.e., in the standby mode or the power saver mode. Upon initiation of a print job at the idle state, as determined at step S301, the process proceeds to step S302 where a page counter is initialized to zero, a narrow media flag is initialized to zero corresponding to full width media, and the interpage gap is initialized to zero corresponding to a standard or nominal interpage gap. All substrates, regardless of the media type, are processed through the printer at a nominal throughput, corresponding to a nominal interpage gap, until a predetermined page count is reached. At step S304, the page counter is incremented by one each time a substrate is processed and the page count is compared to a predetermined number in step S306. If the page count has not exceeded the predetermined number, the process returns to step S304 to process a further substrate.

If the page count has exceeded the predetermined number in step S306, the process flow proceeds to step S307 where a determination is made as to whether the narrow media sensor 92 has detected narrow media in the paper path 50. If narrow media has been detected, the process proceeds to step S309 and the interpage gap is increased by a large increment to decrease the throughput to a low throughput value, such as approximately ⅓ of the nominal throughput, for the remainder of the print job, as indicated at step S311. It should be noted that the interpage gap provided when narrow media is detected may correspond to a maximum interpage gap for the process.

If narrow media is not detected at step S307, the process of the third embodiment proceeds to step S308 and follows the same processing steps as described above for step S108 and the subsequent steps of the first embodiment. With regard to the third embodiment, it may be noted that if narrow media is not sensed at step S307, the throughput may still be reduced to a low throughput value that may correspond to the throughput for narrow media if the temperature T₂ equals or exceeds the upper limit temperature, i.e., 190° C., as indicated at steps S314 and S316.

It is noted that the third embodiment may distinguish between full width media, narrow media and nearly narrow media, where step S307 identifies narrow media by means of a narrow media sensor and may then reduce the throughput by increasing the interpage gap by a large amount to decrease the throughput to approximately ⅓ of the nominal throughput. Nearly narrow media may be identified if the second temperature, T₂, meets the condition 180° C.≦T₂≦190° C., resulting in a small increase in the interpage gap to reduce the throughput to approximately ⅔ of the nominal throughput; and full width media may be identified if the second temperature, T₂, meets the condition T₂<180° C. resulting in the throughput remaining unchanged to convey the media at the nominal throughput.

It should be noted that the process described for the third embodiment may additionally be implemented using a temperature related measurement as described for the second embodiment. That is, the temperature values described for the third embodiment may be replaced with temperature gradient values to control increases in the interpage gap in the process of the third embodiment.

In each of the described embodiments it may be seen that the throughput of media is optimized by providing an initial processing of a predetermined number of pages at a nominal throughput corresponding to a full speed conveyance rate for the particular print job. The throughput is additionally optimized during further processing of the media by incrementally increasing the interpage gap values corresponding to narrow and nearly narrow media.

For all embodiments, the described temperatures and throughput changes are provided for the purpose of illustrating the invention and are not intended to be limiting to the invention.

The operation of the above-described embodiments is not limited to implementation in the particular electrophotographic printer described herein. In particular, the described process may be implemented in any electrophotographic printer that provides a heat fixing device including temperature sensing of a media passing region where media of all widths may pass and temperature sensing where generally only full width media will pass. Accordingly, the process is not limited to printers in which media is aligned to a reference edge located to one side of the paper path, and may include other media alignment configurations including those in which media is aligned to the center of the paper path.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of controlling throughput of media passing through a heat fixing device comprising the steps of:
conveying media to said heat fixing device at a nominal interpage gap;
obtaining a temperature related measurement at said heat fixing device; and
comparing said temperature related measurement to a first predetermined value and if said temperature related measurement is greater than said first predetermined value further comparing said temperature related measurement to a second predetermined value, increasing the interpage gap by a first amount when said temperature related measurement is greater than said first predetermined value and less than said second predetermined value and increasing the interpage gap by a second amount different from said first amount when said temperature related measurement is greater than said second predetermined value, wherein said first predetermined value is less than said second predetermined value.

2. The method as in claim 1 wherein said predetermined temperature related value comprises a temperature of said heat fixing device.

3. The method as in claim 1 wherein said predetermined temperature related value comprises a rate of temperature change of said heat fixing device.

4. The method as in claim 1 including a temperature sensor for measuring a temperature of said heat fixing device in a portion of a media passing region where media having widths less than full width media may not pass through said heat fixing device, and said temperature related measurement is obtained from said temperature sensor.

5. The method as in claim 4 including a further temperature sensor for measuring a temperature of said heat fixing device in a portion of a media passing region where media of all widths may pass through said heat fixing device, said further temperature sensor providing a temperature signal for effecting control of a heater for said heat fixing device.

6. (canceled)

7. The method as in claim 1 wherein said temperature related measurement is correlated to different media types.

8. The method as in claim 7 wherein said different media types comprises full width media, narrow width media and nearly narrow width media, where each media type is conveyed at a different interpage gap based on said temperature related measurement.

9. The method as in claim 1 including detecting whether narrow width media is conveyed to said heat fixing device, and increasing the interpage gap to a maximum value when a predetermined number of substrates are counted and narrow width media is detected.

10. (canceled)

11. A method of controlling throughput of media passing through a heat fixing device comprising the steps of:
conveying media to said heat fixing device;
obtaining a temperature measurement from a first temperature sensor located in a portion of a media passing region where media of all widths may pass through said heat fixing device, said temperature sensor providing a temperature signal for effecting control of a heater for said heat fixing device;
obtaining a temperature related measurement at said heat fixing device from a second temperature sensor for measuring a temperature of said heat fixing device in a portion of a media passing region where media having widths less than full width media may not pass through said heat fixing device; and
comparing said temperature related measurement to a first predetermined value and if said temperature related measurement is greater than said first predetermined value further comparing said temperature related measurement to a second predetermined value, increasing the interpage gap by a first amount when said temperature related measurement is greater than said first predetermined value and less than said second predetermined value and increasing the interpage gap by a second amount different from said first amount when said temperature related measurement is greater than said second predetermined value, wherein said first predetermined value is less than said second predetermined value.

12. The method as in claim 11 wherein said temperature related measurement comprises a temperature of said heat fixing device.

13. The method as in claim 11 wherein said temperature related measurement comprises a rate of temperature change of said heat fixing device.

14. The method as in claim 11 including counting the number of substrates conveyed through said heat fixing device and adjusting said interpage gap when a predetermined number of substrates have been counted.

15. The method as in claim 14 wherein said interpage gap is set to a nominal interpage gap for all media until said predetermined number of substrates have been counted.

16. The method as in claim 11 wherein said temperature related measurement is correlated to different media types.

17. The method as in claim 16 wherein said different media types comprises full width media, narrow width media and nearly narrow width media, where each media type is conveyed at a different interpage gap based on said temperature related measurement.

18. A fuser assembly within an image forming apparatus having a paper path along which substrates travel through the image forming apparatus comprising:
a heating member;
a backup member cooperating with said heating member to form a nip therebetween for fusing images onto substrates passing through said nip;
structure for conveying substrates along the paper path to said nip;
first and second temperature sensors; and
processing structure for determining a temperature measurement from said first temperature sensor located at a portion of a media passing region where media of all widths may pass through said nip, and for determining a temperature related measurement from said second temperature sensor located at a portion of a media passing region where media having widths less than full width media may not pass through said nip; and said processing structure comparing said temperature related measurement to a first predetermined value and if said temperature related measurement is greater than said first predetermined value further comparing said temperature related measurement to a second predetermined value, increasing the interpage gap by a first amount when said temperature related measurement is greater than said first predetermined value and less than said second predetermined value and increasing the interpage gap by a second amount different from said first amount when said temperature related measurement is greater than said second predetermined value, wherein said first predetermined value is less than said second predetermined value.

19. (canceled)

20. A fuser assembly as in claim 18 wherein said processor structure determines if a predetermined number of substrates have passed through said nip prior to adjusting said interpage gap.

21. The method of claim 1, wherein said first amount of interpage gap increase is less than said second amount.

22. The method of claim 11, wherein said first amount of interpage gap increase is less than said second amount.

23. A fuser assembly as in claim 18, wherein said first amount of interpage gap increase is less than said second amount.
